(19) United States
(12) Patent Application Publication
(10) Pub. No.: US 2008/0009571 A1
(43) Pub. Date: Jan. 10, 2008

(54) Aliphatic Polyester-Acrylic Blend Molding Composition Having Good Ductility and Weatherability

(76) Inventors: Matthew R. Pixton, Mt. Vernon, IN (US); Olivier Sevvet, Rennes (FR); Dominique Daniel Arnould, Ossendrecht (NL); Peter H. Th. Vollenberg, Evansville, IN (US); Paul Honigfort, Gaithersburg, MD (US); Christopher L. Hein, Evonsville, IN (US)

Correspondence Address: MARINA LARSON & ASSOCIATES, LLC;ATTN: GE - VALOX, P.O. BOX 4928, DILLON, CO, 80435-4928, US

(21) Appl. No.: 11/680,382

(22) Filed: Feb. 28, 2007

Related U.S. Application Data
(63) Continuation of application No. 10/248,932, filed on Mar. 3, 2003, now abandoned.
(60) Provisional application No. 60/361,431, filed on Mar. 1, 2002.

(51) Int. Cl. C08K 5/34; C08G 18/62; C08K 5/3415; C08L 67/02; C08K 5/3435; C08K 5/23

(52) U.S. Cl. 524/98; 524/102; 524/104; 524/106; 524/190; 524/502; 525/173; 525/451

(57) ABSTRACT

A molding composition has a bulk resin component formed from: a) 5 to 93 percent by weight of cycloaliphatic polyester resin such as poly(1,4-cyclohexane-dimethanol-1,4-dicarboxylate having a melt viscosity of at least 6000 poise; b) 5 to 93 percent by weight of an acrylate polymer or co-polymer; and c) 2 to 30 percent by weight of an impact modifier with a a shell comprising a repeating units derived from a C1-12 alkyl(meth)acrylate and a rubbery core having weatherability properties. The composition may further include a polycarbonate polymer or a styrene-acrylonitrile polymer as a phase compatabilizer as well as other conventional additives such as pigments, mineral fillers, antioxidants and the like. The composition has improved ductility, impact strength and weatherability.

### CROSS REFERENCE TO RELATED APPLICATIONS

The present application claims the benefit of U.S. Provisional Application No. 60/361431, filed Mar. 1, 2002, the disclosure of which is incorporated herein by reference.

### BACKGROUND OF INVENTION

The present invention relates to molding compositions based upon blends of thermoplastic polyester resin and thermoplastic polyacrylate resin binder materials.

Molding compositions based upon thermoplastic polyacrylate binder materials such as polymethyl methacrylate (PMMA) have good hardness, gloss and weatherability. However they have poor ductility, are brittle and have limited solvent resistance. Molding compositions based upon thermoplastic cycloaliphatic polyester resin binder materials have good ductility, impact strength and weatherability properties at least in the case of cycloaliphatic polyesters which are substantially devoid of aromatic constituents.

It is possible to formulate molding compositions from blends of different thermoplastic binder materials, in order to impart the desirable properties of each of the resins into the blend. Patent application no. EP 902052 describes a UV-stable impact-modified, molding composition containing poly(1,4-cyclohexane-dimethanol-1,4-dicarboxylate) or “PCCD,” and from about 5% up to about 50% by weight, based upon the polymer mixture, of a high molecular weight, thermoplastic acrylic polymer or copolymer. The PCCD used herein has a melt viscosity of 4500-5000.

Blends of wholly or partially aliphatic polyesters with acrylic polymers of the prior art may exhibit brittle failure at room temperature, and hence, would be unsuitable for many applications. In some cases, the addition of pigments and colorants is one root cause of the poor impact performance with phase coalescence and morphology coarsening being observed in the poor impact samples.

The present invention relates to molding compositions comprising blends of certain thermoplastic polyester resin and thermoplastic polyacrylate resin binder materials, with improved long term weathering performance and impact performance. Applicants have found that the use of cycloaliphatic polyesters having a melt viscosity of about 6000 poise or greater surprisingly gives compositions comprising polyester and thermoplastic polyacrylate blends excellent long term weathering performance and impact strength, even in the presence of pigments and colorants in combination with abusive processing conditions

### SUMMARY OF INVENTION

The present invention relates to a method to improve the ductility and weatherability properties of the UV-stable impact-modified, cycloaliphatic polyester resin molding compositions and a molding composition with these properties. The composition comprises a bulk resin component consisting essentially of: a) 5 to 93 percent by weight of cycloaliphatic polyester resin such as poly(1,4-cyclohexane-dimethanol-1,4-dicarboxylate having a melt viscosity of at least 6000 poise; b) 5 to 93 percent by weight of an acrylate polymer or co-polymer; and c) 2 to 30 percent by weight of an impact modifier consisting essentially of a shell comprising a repeating units derived from a C1-12 alkyl(meth)acrylate and a rubbery core having weatherability properties. The composition may further include a polycarbonate polymer or a styrene-acrylonitrile polymer as a phase compatabilizer as well as other conventional additives such as pigments, mineral fillers, antioxidants and the like.

### DETAILED DESCRIPTION

Since aliphatic polyester resins have very high UV-stability properties, they are known and preferred materials for use as a bulk components in molding compositions. However, in the present invention, Applicants have discovered that cyclo-aliphatic polyester resins having a melt viscosity of at least 6000 poise, when blended with acrylic ester polymers or copolymers, provide a composition having improved UV-stability/weatherability properties, as well as unexpected increases in the ductility and toughness beyond what could be expected according to the rule of mixtures.

Applicants have also found that the ductility and toughness of UV-stable weatherable blends containing a thermoplastic polyacrylate resin, a thermoplastic cycloaliphatic polyester resin and a poly(methyl methacrylate) core shell impact modifier, can be enhanced by the presence of a phase compatibilizing agent.

Cycloaliphatic Polyester Component. The cycloaliphatic polyester resin comprises a polyester having repeating units of the formula 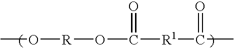
where at least one R or R1 is a cycloalkyl containing radical.

In one embodiment, R and R1 are cycloalkyl radicals independently selected from the following formula: 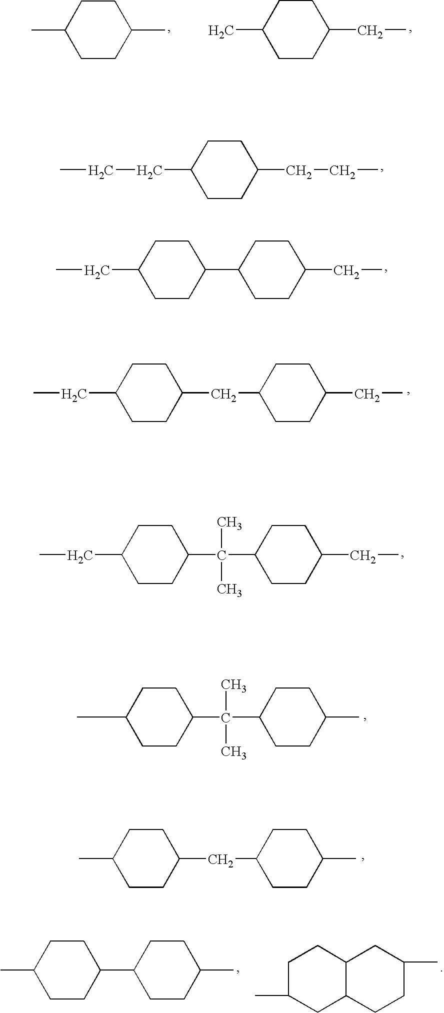
wherein the cycloaliphatic radical R1 is derived from the 1,4-cyclohexyl diacids and most preferably greater than 70 mole % thereof in the form of the trans isomer. The cycloaliphatic radical R is derived from the 1,4-cyclohexyl primary dials such as 1,4-cyclohexyl dimethanol, most preferably more than 70 mole % thereof in the form of the trans isomer.

The polyester resins are typically obtained through the condensation or ester interchange polymerization of the diol or dial equivalent component with the diacid or diacid chemical equivalent component.

In one embodiment, the polyester is a condensation product where R is the residue of an aryl, alkane or cycloalkane containing dial having 6 to 20 carbon atoms or chemical equivalent thereof, and R1 is the decarboxylated residue derived from an aryl, aliphatic or cycloalkane containing diacid of 6 to 20 carbon atoms or chemical equivalent thereof with the proviso that at least one R or R1 is cycloaliphatic. Preferred polyesters of the invention will have both R and R1 cycloaliphatic.

In another embodiment, the cycloaliphatic polyesters are condensation products of aliphatic diacids, or chemical equivalents and aliphatic diols, or chemical equivalents. The present cycloaliphatic polyesters may be formed from mixtures of aliphatic diacids and aliphatic dials, and in one embodiment, containing at least 50 mole % of cyclic diacid and/or cyclic diol components, the remainder, if any, being linear aliphatic diacids and/or dials. The cyclic components are necessary to impart good rigidity to the polyester and to allow the formation of transparent/translucent blends due to favorable interaction with the polycarbonate resin.

In one embodiment, the diols used in the preparation of the polyester resins of the present invention are straight chain, branched, or cycloaliphatic alkane diols and may contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane dial; 1,3- and 1,5-pentane dial; dipropylene glycol; 2-methyl-1,5-pentane diol; 1,6-hexane dial; dimethanol decalin, dimethanol bicyclo octane; 1,4-cyclohexane dimethanol and particularly its cis- and trans-isomers; 2,2,4,4-tetramethyl-1,3-cyclobutanediol (TMCBD), triethylene glycol; 1,10-decane diol; and mixtures of any of the foregoing. Preferably a cycloaliphatic diol or chemical equivalent thereof and particularly 1,4-cyclohexane dimethanol or its chemical equivalents are used as the diol component.

Chemical equivalents to the diols include esters, such as dialkylesters, diaryl esters and the like.

The diacids useful in the preparation of the aliphatic polyester resins of the present invention preferably are cycloaliphatic diacids. This is meant to include carboxylic acids having two carboxyl groups each of which is attached to a saturated carbon. Preferred diacids are cyclo or bicyclo aliphatic acids, for example, decahydro naphthalene dicarboxylic acids, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or chemical equivalent. Linear dicarboxylic acids like adipic acid, azelaic acid, dicarboxyl dodecanoic acid and succinic acid may also be useful.

Cyclohexane dicarboxylic acids and their chemical equivalents can be prepared, for example, by the hydrogenation of cycloaromatic diacids and corresponding derivatives such as isophthalic acid, terephthalic acid or naphthalenic acid in a suitable solvent such as water or acetic acid using a suitable catalysts such as rhodium supported on a carrier such as carbon or alumina. See, Friefelder et al., Journal of Organic Chemistry, 31, 3438 (1966); U.S. Pat. Nos. 2,675,390 and 4,754,064. They may also be prepared by the use of an inert liquid medium in which a phthalic acid is at least partially soluble under reaction conditions and with a catalyst of palladium or ruthenium on carbon or silica. See, U.S. Pat. Nos. 2,888,484 and 3,444,237.

Typically, in the hydrogenation, two isomers are obtained in which the carboxylic acid groups are in cis- or trans-positions. The cis- and trans-isomers can be separated by crystallization with or without a solvent, for example, n-heptane, or by distillation. The cis-isomer tends to blend better; however, the trans-isomer has higher melting and crystallization temperatures and may be preferred. Mixtures of the cis- and trans-isomers are useful herein as well.

When the mixture of isomers or more than one diacid or diol is used, a copolyester or a mixture of two polyesters may be used as the present cycloaliphatic polyester resin.

Chemical equivalents of these diacids include esters, alkyl esters, e.g., dialkyl esters, diaryl esters, anhydrides, salts, acid chlorides, acid bromides, and the like. The preferred chemical equivalents comprise the dialkyl esters of the cycloaliphatic diacids, and the most favored chemical equivalent comprises the dimethyl ester of the acid, particularly dimethyl-1,4-cyclohexane-dicarboxylate.

In one embodiment, the cycloaliphatic polyester is poly(cyclohexane-1,4-dimethylene cyclohexane-1,4-dicarboxylate) also referred to as poly(1,4-cyclohexane-dimethanol-1,4-dicarboxylate) (PCCD) which has recurring units of formula: 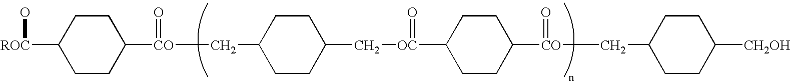
wherein R is H or a lower alkyl. With reference to the previously set forth general formula, for PCCD, R is derived from 1,4 cyclohexane dimethanol; and R1 is a cyclohexane ring derived from cyclohexanedicarboxylate or a chemical equivalent thereof. The favored PCCD has a cis/trans formula.

The polyester polymerization reaction is generally run in the melt in the presence of a suitable catalyst such as a tetrakis (2-ethyl hexyl)titanate, in a suitable amount, typically about 50 to 400 ppm of titanium based upon the final product.

Also contemplated herein are the above polyesters with from about 1 to about 50 percent by weight, of units derived from polymeric aliphatic acids and/or polymeric aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

The aliphatic polyesters for use in the blends of the present invention have a melt viscosity of at least 6000 (@250° C). In one embodiment, the viscosity is at least 7000. In a further embodiment, the melt viscosity is at least about 8,000 poise.

In one embodiment, the aliphatic polyesters used have a glass transition temperature (Tg) which is above 50° C., more preferably above 80° C. and most preferably above about 100° C.

Alkyl Acrylate Polymer Component. The alkyl acrylate polymer serves to provide a composition which is less expensive than one based upon the polyester alone, has improved UV-stability and weatherability, and has significantly higher stiffness than one based upon the polyester alone, when used in the proper proportions or ratio. In one embodiment, the alkyl acrylate polymers are homopolymers or copolymers containing the structure:

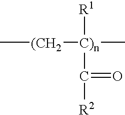

in which R1 is H or C1-C6 alkyl, preferably methyl, and R2 is C1-C12 alkyl, cycloalkyl or alkyl aryl, preferably methyl. In the case of acrylic ester homopolymers, n=100 to 100,000. In the case of copolymers, the molecular weight thereof will be within the molecular weight range of the homopolymer. In all cases the acrylic ester polymer preferably has a glass transition temperature above about 800° C. In general the suitable acrylic polymer or copolymer will have a glass transition temperature of about 100° C. and is immiscible with the polyester to provide a microphase-separated mixture having good toughness and non transparency.

In one embodiment, the acrylic ester polymer may be a copolymer or terpolymer of the acrylic ester monomer and up to about 50% by weight of one or two other ethylenically-unsaturated or vinyl co-monomers such as acrylonitrile, styrene, alkyl styrene, alpha olefins such as ethylene and propylene, vinyl esters such as vinyl acetate, unsaturated diacids or anhydrides such as maleic acid or anhydride, or maleimide.

In one embodiment, the acrylic polymer or copolymer of the blend is a (methyl methacrylate) homopolymer, PMMA. In yet another embodiment, the PMMA homopolymer is PMMA V920A which is commercially available from Ato Haas under the trademark Plexiglass.

In one embodiment, the acrylic polymer or copolymer of the blend is present in an amount of about between about 5% to 95% by weight of the total weight of the blend. In a second embodiment, about 5 to 60 wt. %. In a third embodiment, about 20 to 40 wt. %.

Impact Modifier Component. The non-crystalline thermoplastic resin (i.e., the alkyl acrylate) and the crystalline thermoplastic resin (i.e., the cycloaliphatic polyester) have inherently poor compatibility with each other so that adhesiveness at an interface of the two phase structure is not good, whereby two phases can hardly take uniform and fine forms. Applicants have found that the addition of the impact modifier component, besides changing the interface characteristics of dispersed phases and/or heightening phase dispersion and improve compatibility of the resin mixture so as to be shown by improved impact strength (toughness), also improves the stiffness properties. It is quite surprising for the reason that stiffness and toughness are generally inversely proportional to each other.

The substantially amorphous impact modifier copolymer resin to be added to the polymer blend may comprise one of several different rubbery modifiers or combinations of two or more of these modifiers. Suitable are the groups of modifiers known as acrylic rubbers, ASA rubbers, acrylate or diene rubbers, organosiloxane rubbers, EPDM rubbers, SBS or SEBS rubbers, ABS rubbers, glycidyl ester impact modifiers, a methacrylic grafted polymer of an acrylate elastomer, alone or co-polymerized with a vinyl aromatic compound.

The term acrylic rubber modifier can refer to multi-stage, core-shell, interpolymer modifiers having a cross-linked or partially crosslinked (meth)acrylate rubbery core phase, preferably butyl acrylate. Associated with this cross-linked acrylic ester core is an outer shell of a methyl methacrylate which interpenetrates the rubbery core phase. Incorporation of small amounts of other monomers such as acrylonitrile or (meth) acrylonitrile within the resin shell also provides suitable impact modifiers. The interpenetrating network is provided when the monomers forming the resin phase are polymerized and cross-linked in the presence of the previously polymerized and cross-linked (meth)acrylate rubbery phase.

In one embodiment, the impact modifiers are graft or core shell structures with a rubbery component with a Tg below 0° C., preferably between about −40° to −80° C., composed of poly alkylacrylates or polyolefins grafted with PMMA or SAN. Preferably the rubber content is at least 40 wt %, most preferably between about 70-90 wt %.

In one embodiment of the invention, the grafted polymers are the acrylic core-shell polymers of the type available from Rohm & Haas, for example Acryloid EXL3330. In another embodiment, the impact modifier comprises a two stage polymer having an n-butyl acrylate based rubbery core and a second stage polymerized from methylmethacrylate alone or in combination with styrene. Also present in the first stage are cross linking monomers and graft linking monomers.

In one embodiment of the invention, the impact modifier is present in an amount of about 2% to 30% by weight of the total weight of the compositions. In another embodiment, the impact modifier is an acrylic rubber, such as a core shell modifier having a poly(methyl methacrylate) PMMA shell and a butyl acrylate core, or an acrylonitrile-styrene-acrylate (ASA) rubber, or an ethylene-propylene-diene graft styrene-acrylonitrile rubber (EPDM-g-SN).

Optional Phase Compatibilizing Agent. In one embodiment, in addition to the impact modifiers, a phase compatibilizing agent can be added. In one embodiment, the phase compatibilizing agent is added in an amount of about 5 to 40 wt. %. In another embodiment, the amount is about 10 to 20 wt. %.

In one embodiment, the phase compatibilizing agent is selected from polycarbonate (PC) polymers, especially aromatic polyesters such as bisphenol A (BPA) PC, and styrene-acrylonitrile copolymers, particularly styrene-acrylonitrile copolymers containing 25% - 35% of acrylonitrile.

Other Optional Components. The present weatherable molding compositions may be reinforced or stiffened by the inclusion of a mineral filler such as talc, clay, silica, wollastonite, barite or a fibrous glass or carbon filler, preferably glass fibers, in amounts ranging between about 5% and 50% by weight of the total composition, most preferably between 1 0% and 30%.

In one embodiment, additives such as antioxidants, thermal stabilizers, mold release agents, antistatic agents, whitening agents, colorants, plasticizers, minerals such as talc, clay, mica, barite, wollastonite and other stabilizers including but not limited to UV stabilizers, such as benzotriazole, supplemental reinforcing fillers such as flaked or milled glass, and the like, flame retardants, pigments, additional resins or combinations thereof may be added to the compositions of the present invention. The different additives that can be incorporated in the compositions are commonly used and known to one skilled in the art. Illustrative descriptions of such additives may be found in R. Gachter and H. Muller, Plastics Additives Handbook, 4th edition, 1993.

Optional Pigment Components. In one embodiment, the UV-stable weatherable blends further comprises a pigment to give the finished article a “visual effect.” In general, the effect pigment is a metallic-effect pigment, a metal oxide-coated metal pigment, a platelike graphite pigment, a platelike molybdenumdisulfide pigment, a pearlescent mica pigment, a metal oxide-coated mica pigment, an organic effect pigment, a layered light interference pigment, a polymeric holographic pigment or a liquid crystal interference pigment. In one embodiment, the effect pigment is a metal effect pigment selected from the group consisting of aluminum, gold, brass and copper metal effect pigments; especially aluminum metal effect pigments. In another embodiment, the effect pigments are pearlescent mica pigments or a large particle size, preferably platelet type, organic effect pigment selected from the group consisting of copper phthalocyanine blue, copper phthalocyanine green, carbazole dioxazine, diketopyrrolopyrrole, iminoisoindoline, irninoisoindolinone, azo and quinacridone effect pigments.

In yet another embodiment, the colored pigments include organic pigments selected from the group consisting of azo, azomethine, methine, anthraquinone, phthalocyanine, perinone, perylene, diketopyrrolopyrrole, thioindigo, dioxazine iminoisoindoline, dioxazine, iminoisoindolinone, quinacridone, flavanthrone, indanthrone, anthrapyrimidine and quinophthalone pigments, or a mixture or solid solution thereof; especially a dioxazine, diketopyrrolopyrrole, quinacridone, phthalocyanine, indanthrone or iminoisoindolinone pigment, or a mixture or solid solution thereof.

Examples of colored organic pigments include C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, S.R. 135, C.I. Pigment Brown 23, C.I. Pigment Yellow 109, C.I. Pigment Yellow 110, C.I. Pigment Yellow 147, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 37, C.I. Pigment Violet 19, C.I. Pigment Green 7, C.I. Pigment Green 36, or a mixture or solid solution thereof.

Examples of colored inorganic pigments include those selected from the group consisting of metal oxides, such as TiO₂, antimony yellow, lead chromate, lead chromate sulfate, lead molybdate, ultramarine blue, cobalt blue, manganese blue, chrome oxide green, hydrated chrome oxide green, cobalt green and metal sulfides, such as cerium or cadmium sulfide, cadmium sulfoselenides, zinc ferrite, bismuth vanadate and mixed metal oxides.

In one embodiment, the colored pigment is a transparent organic pigment, example, a transparent organic pigment having a particle size range of below 0.2 μm, preferably below 0.1 μm. In another embodiment, the colored pigments are transparent quinacridones in their magenta and red colors; the transparent yellow pigments, e.g. the isoindolinones or the yellow quinacridone/quinacridonequinone solid solutions; transparent copper phthalocyanine blue and halogenated copper phthalocyanine green; or the highly-saturated transparent diketopyrrolopyrrole or dioxazine pigments.

In one embodiment of the invention, the colored pigment is a partially chlorinated copper phthalocyanine commercially available from BASF as Heliogen Blue K6915.

The pigment compositions are generally used in the form of a powder which is subsequently incorporated into the blends of the invention. Applicants have found use of the pigments in “resin carriers” that are wholly or partially aliphatic polyesters and acrylic polymers obviates the problem experienced in the prior art of insufficient dispersion of organic pigments at high loading levels and resulting reduction in impact strength.

In one embodiment, the pigments are dispersed in the cycloaliphatic polyester as a carrier. In yet another embodiment, the pigments are dispersed or pre-blended in polymethylmethacrylate (PMMA) as the resin carrier.

In one embodiment, the pigment is dry blended with the resin carrier PCCD or PMMA in any suitable device which yields a nearly homogenous mixture of the pigment and the resin carrier for a color concentrate. Such devices are, for example, containers like flasks or drums which are submitted to rolling or shaking, or specific blending equipment like for example the TURBULA mixer from W. Bachofen, CH-4002 Basel, or the P-K TWIN-SHELL INTENSIFIER BLENDER from Patterson-Kelley Division, East Stroudsburg, Pa. 18301. The use of color concentrates is quite advantageous due to their low processing temperature and compatibility with the phase compatibilizing agents.

Process for Forming the Blends of the Invention. The method of blending the present compositions can be carried out by conventional techniques. One convenient method comprises melt blending the polyester, acrylic, impact modifier and other ingredients in powder or granular form, extruding the blend and comminuting into pellets or other suitable shapes. The ingredients are combined in any usual manner, e.g., by dry mixing followed by mixing in the melted state in an extruder.

In one embodiment, the impact-modified cycloaliphatic polyester/acrylic ester blend polymer compositions comprise: a) from about 50% to 95% by weight, most preferably 50-80%, of a cycloaliphatic polyester resin having a melt viscosity of at least 6000 poise; b) about 5% to 50% by weight, most preferably 45-20%, of an acrylic ester polymer or copolymer; c) from 2 to about 30 parts by weight, most preferably 5-25%, of a rubbery impact modifier comprising a substantially amorphous resin comprising one of several different modifiers or combinations of two or more of these modifiers. Applicants have found that the blends of the present invention exhibit a delta E shift of leass than 5 after 2500 kJ of J1960 exposure.

The compositions of the inventions can be used to form a variety of articles. Representative, non-limiting examples of such articles include components for use in for outdoor applications such as fenders, bumpers, grills, personal watercrafts, snowmobiles lawn mowers, tractors, automotives, heavy duty machines, and golf cars.

The examples below, is merely representative of the work that contributes to the teaching of the present application. The following materials are used in the examples of the present invention:

PCCD is a cycloaliphatic ester made by reacting equimolar amounts of dimethyl trans-1,4-cyclohexanedicarboxylate (t-DMCD) with 1,4-cyclohexanedimethanol (CHDM) in the presence of a titanium catalyst. Depending on the experiments, the polymer either has a melt viscosity of 4500-5000 poise (@250° C.) or 6000 poise.

Irganox® 1076—Hindered Phenolic Anti-Oxidant from Ciba-GeigyTinuvin® 234—UV absorber, substituted hydroxyphenyl benzotriazole from Ciba-Geigy CorporationPMMA V920A—Plexiglass poly (methyl methacrylate) from Ato Haas.

Irgafos® 68—an aryl phosphite stabilizer from Ciba Geigy Corporation.

Tinuvin® 622LD UVabsorber, substitute hydroxytetramethyl benzotriazole from Ciba-Geigy CorporationAcryloid® EXL 3330—an acrylic rubber core shell impact modifier from Rohm & Haas.

ERL is a cycloaliphatic epoxy resin from Union Carbide.

As set forth in the following examples, the following properties are measured and according to the following procedures:

Notched Izod (NI): This test procedure is based on the ASTM D256 method. The results of the test is reported in terms of energy absorbed per unit of specimen width, and expressed in foot times pounds per inch (Ft.Lbs./In.). Typically the final test result is calculated as the average of test results of five test bars.

Dynatup (DYN TE): This test procedure is based on the ASTM D3763 method and was performed on a Dynatup brand impact test machine. This procedure provides information on how a material behaves under multiaxial deformation conditions. The deformation applied is a high speed puncture. An example of a supplier of this type of testing equipment is Dynatup. Reported as test results are the so-called total energy values at various temperatures, which are expressed in foot times pounds (Ft.Lbs.). The final test result is calculated as the average of the test results of typically ten test plaques.

Melt viscosity ratio (MVR): This test procedure is based on the ASTM D1238 method. The equipment used is an extrusion plastometer equipped with an automatic timer. A typical example of this equipment would be the Tinius Olson MP 987. Before testing, the samples are dried for one hour at 150° C. The testing conditions are a melt temperature of 265° C., a total load of 5,000 gram, an orifice diameter of 0.0825 inch, and a dwell time of 6 minutes. The test result is expressed in the unit cm³/10 min.

Flexural Modulus (FM): This test procedure for measuring stiffness is based on the ASTM D790 method. Typical test bars have the following dimensions: ⅛ inch by ½ inch by 2½ inch. The final test result is calculated as the average of test results of five test bars. The test involves a three point loading system utilizing center loading on a simply supported beam. Instron and Zwick are typical examples of manufacturers of instruments designed to perform this type of test. The flexural modulus is the ratio, within the elastic limit, of stress corresponding strain and is expressed in pounds per square inch (psi).

Gloss Retention (J1960 Gloss)—The J 1960 test is a SAE automotive specification for accelerated weathering, with gloss values measured using ASTM D523.

60 Gloss: This test is done according to ASTM D523.

Color Retention (J1960 Color)—This test measures color change (δ E) of the weathered sample using a Cielab System.

Weathering under SAE J 1960 conditions—J1960 test is an automotive specification for accelerated weather, as known in the art. The protocol is as follows. Un-textured Gardner chips are weathered in a Xenon Arc Atlas Ci65/DMC weatherometer using the SAEJ1960 JUN89 method. A quartz inner and borosilicate glass outer filter is used. Samples are held in a two tier rack with the conditions as follows:

[t1]

| CONTROL | DARK CYCLE | LIGHT CYCLE |
|---|---|---|
| Irradiance | — | 0.55 ± 0.01 w/m² at 340 nm |
| Black panel temp | 38 ± 2° C. | 70 ± 2° C. |
| Wet bulb depression | 0° C. | 12° C. |
| Dry bulb | 38 ± 2° C. | 47 ± 2° C. |
| Relative humidity | 95 ± 5% | 50 ± 5% |
| Conditioning water | 40 ± 4° C. | 45 ± 4° C. |

A #180 cam is used providing 40 min. light followed by 20 min. of light and front water spray followed by 60 min. light, followed by 60 min. dark with water spray repeated. Total 120 min. light, 60 min. dark, and with light time of 16 hrs. per day.

After weathering, the samples are measured at 625, 1250, 1875 and 2500 KJ/m2 total irradiance. Approximate days (with machine running 24 hours/day) would be 19.7, 39.5, 59.2 and 78.9 days, (3, 6, 12 and 17 weeks).

The Examples in the tables below are prepared by blending all ingredients in a bucket blender until a good homogeneity of the blend was achieved. Formulations are extruded on a vacuum-vented 30 mm WP twin screw operated at 500 F (die head zone=480 F) with a screw speed of 250 rpm.

### EXAMPLE 1

In Table 1 fourteen formulations in accordance with the invention (E1-14) are provided along with the results of mechanical testing of these formulations. In addition, a comparative example H6 (which is example E6 taken from EP 902052) is included in which the PCCD used had a melt viscosity of 4500-5000 poise. In the examples in accordance with the invention, the PCCD used had a melt viscosity of 6000 poise. No degradation in gloss or color retention was observed after weathering under J1960 conditions. The comparison of the notched izod results for comparative example H6 to the immediately flanking compositions according to the invention (E13 and 14) is particularly striking, with impact strength in the compositions being nearly 4× that observed in the comparative example.

[t2]

TABLE 1

| | E1 | E2 | E3 | E4 | E5 | E6 | E7 | E8 | E9 |
|---|---|---|---|---|---|---|---|---|---|
| PCCD 6K | 49.3 | 49.3 | 54.3 | 55.8 | 58.8 | 59.3 | 59.3 | 63.3 | 63.3 |
| poise | | | | | | | | | |
| PCCD 4.5-5K | | | | | | | | | |
| Poise | | | | | | | | | |
| PMMA | 34 | 34 | 34 | 30 | 27 | 34 | 34 | 20 | 20 |
| V920A | | | | | | | | | |
| Acryloid EXL | 15 | 15 | 10 | 12.5 | 12.5 | 5 | 5 | 15 | 15 |
| 3330 | | | | | | | | | |
| Irg 1076 | 0.2 | 0.2 | 0.2 | 0.2 | 0.2 | 0.2 | 0.2 | 0.2 | 0.2 |
| Irgafos 168 | 0.2 | 0.2 | 0.2 | 0.2 | 0.2 | 0.2 | 0.2 | 0.2 | 0.2 |
| Tinuvin 234 | 0.3 | 0.3 | 0.3 | 0.3 | 0.3 | 0.3 | 0.3 | 0.3 | 0.3 |
| ERL | 0.1 | 0.1 | 0.1 | 0.1 | 0.1 | 0.1 | 0.1 | 0.1 | 0.1 |
| Tinuvin 622 | 1.0 | 1.0 | 1.0 | 1.0 | 1.0 | 1 | 1 | 1.0 | 1.0 |
| LD | | | | | | | | | |
| Phosphorous | | | | | | | | | |
| Acid | | | | | | | | | |
| MVR | 42 | 48 | 51 | 46 | 47 | 60 | 58 | 39 | 37 |
| @265 C., 5 Kg | | | | | | | | | |
| (cm3/10 min) | | | | | | | | | |
| MV (poise) | 4600 | 4600 | 4700 | 4800 | 4900 | 4700 | 4700 | 5200 | 5100 |
| FM (kpsi) | 231 | 203 | 235 | 223 | 221 | 260 | 263 | 198 | 196 |
| FS (psi) | 8000 | 7500 | 8700 | 7900 | 7800 | 9700 | 9800 | 7300 | 7100 |
| TM (kpsi) | 220 | 192 | 234 | 212 | 209 | 271 | 274 | 181 | 182 |
| NI (RT) | 1.6 | 1.6 | 3.2 | 9.6 | 15.0 | 4.7 | 4.7 | 26.8 | 26.8 |
| Dyn TE (ft- | 41.0 | 37 | 37 | 34 | 24.0 | 40 | 33 | 37.0 | 38.0 |
| lbs) | | | | | | | | | |
| HDT@66 psi | 68.0 | 60 | 68 | 64 | 63.0 | 69.0 | 68.0 | 60.0 | 60.0 |
| [t3] | | | | | | | | | |

| | E10 | E11 | E12 | E13 | H6 | E14 |
|---|---|---|---|---|---|---|
| PCCD 6K poise | 63.3 | 63.3 | 63.8 | 64.0 | | 68.3 |
| PCCD 4.5-5K | | | | | 67.1 | |
| Poise | | | | | | |
| PMMA V920A | 25 | 20 | 28 | 23 | 22.4 | 25 |
| Acryloid EXL | 10 | 15 | 7.5 | 11.3 | 10 | 5 |
| 3330 | | | | | | |
| Irg 1076 | 0.2 | 0.2 | 0.2 | 0.2 | .2 | 0.2 |
| Irgafos 168 | 0.2 | 0.2 | 0.2 | 0.2 | | 0.2 |
| Tinuvin 234 | 0.3 | 0.3 | 0.3 | 0.3 | .3 | 0.3 |
| ERL | 0.1 | 0.1 | 0.1 | 0.1 | | 0.1 |
| Tinuvin 622 LD | 1.0 | 1.0 | 1.0 | 1.0 | | 1.0 |
| Phosphorous | | | | | 0.05 | |
| Acid | | | | | | |
| MVR @265 C., | 40 | 42 | 57 | 47 | | 61.5 |
| 5 Kg (cm3/10 min) | | | | | | |
| MV (poise) | 5000 | 5100 | 5000 | 5100 | 4400 | 5100 |
| FM (kpsi) | 217 | 210 | 236 | 208 | 344 | 236 |
| FS (psi) | 7500 | 7600 | 8500 | 7700 | | 8500 |
| TM (kspi) | 200 | 190 | 227 | 204 | | 228 |
| NI (RT) | 19.4 | 26.8 | 15.4 | 22.6 | 6 | 20.9 |
| Dyn TE (ft-lbs) | 42 | 45 | 37 | 39 | 37 | 42 |
| HDT@66 psi | 61 | 62 | 62 | 61 | | 63.0 |

### EXAMPLE 2

Many outdoor applications involving engineered thermoplastics require excellent color retention after exposure to the harsh conditions of light, oxygen, and water. Low color shifts may be achieved in some colors, however, blue colors present a challenge to the supplier of weatherable molded-in-color articles. Phthalocyanine blue is known to be a lightfast colorant, however, the extent of stability may be resin dependent. Therefore, a given phthalo blue may or may not work well in outdoor applications. This problem is more pronounced in blue tints, where minor color shifts are easily detectable both visually and instrumentally. A weatherable blue phthalocyanine pigment is needed for applications that require stable blue tints.

Tint tones of a blue copper phthalocyanine (BASF Heliogen Blue K6915 provide a substantial improvement in weatherability relative and improved color retention compared to K7100 (BASF) or Pigment Blue 15:4 (BASF) when exposed to ASTM G26 Xenon arc conditions. For comparison purposes, two different tint tones were prepared where the phthalocyanine loading level is varied equally for each pigment grade.

These pigments were incorporated into an impact-modified blend of PCCD/PMMA having the composition:
[t4]

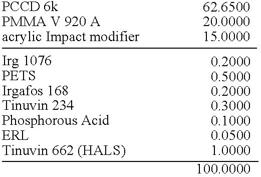

Color plaques for weathering were prepared by injection-molding at 500 F and tested in accordance with ASTM G26 methodology. As shown in the following table, color-retention performance for K6915R1259 was much superior to K7100R1215.

[t5]

| CRIOLL | | | |
|---|---|---|---|
| | D65 10 | | |
| ASTM G26 | DEGREE | | |
| METHOD | CIELAB | | |
| 0125% K6915 | EDXX0032-7 | | |
| 1.0% TiO2 | | | |
| | | Trial | DE* |
| | | 360HR/G26 | 0.089 |
| | | 720HR | 0.159 |
| | | 1440HR | 0.649 |
| | | 2160HR | 1.276 |
| | | 2160HR, WAXED | 1.058 |
| 0.25% R1259 | EDXX0032-8 | | |
| 1.0% TiO2 | | | |
| | | Trial | DE* |
| | | 360HR/G26 METHOD | 0.359 |
| | | 720HR | 0.288 |
| | | 1440HR | 0.158 |
| | | 2160HR | 1.358 |
| | | 2160HR, WAXED | 0.153 |
| 0.125% R1215 | EDXX0032-3 | 02220-3, STD/364806 | |
| 1.0% TiO2 | | | |
| | | Trial | DE* |
| | | 1 20-3, 360HR/G26 | 0.946 |
| | | 2 20-3, 720HR | 1.45 |
| | | 3 20-3, 1440HR | 2.408 |
| | | 4 20-3, 2160HR/FINAL | 3.567 |
| | | 5 20-3, 2160HR, WAXED | 3.357 |
| 0.25% R1215 | EDXX0032-4 | | |
| 1.0% TiO2 | | | |
| | | Trial | DE* |
| | | 360HR/G26 | 0.943 |
| | | 720HR | 1.439 |
| | | 1440HR | 2.479 |
| | | 2160HR | 3.548 |
| | | 2160HR, WAXED | 3.187 |

It should be understood that the foregoing description is only illustrative of the invention. Various alternative modifications can be employed by those skilled in the art without departing from the scope of the invention. Accordingly, the present invention is intended to embrace all such alternative, modifications and variances which fall within the scope of the appended claims.

1. A molding composition comprising:
a bulk resin component consisting essentially of:
a) 5 to 93 percent by weight of cycloaliphatic polyester resin having a melt viscosity of at least 6000 poise;
b) 5 to 93 percent by weight of an acrylate polymer or co-polymer; and
c) 2 to 30 percent by weight of an impact modifier consisting essentially of a shell comprising repeating units derived from a C1-12 alkyl(meth)acrylate and a rubbery core having weatherability properties,
wherein the bulk resin component makes up at least 50% of the molding composition.

2. The composition of claim 1, wherein the cycloaliphatic polyester resin is poly(1,4-cyclohexane-dimethanol 1,4 dicarboxylate (PCCD).

3. The composition of claim 2, wherein the (PCCD) is present in the bulk resin component in an amount of 40-80% by weight.

4. The composition of claim 1, wherein the cycloaliphatic polyester resin is present in the bulk resin component in an amount of 40-80% by weight.

5. The composition of claim 1, wherein the acrylate polymer or co-polymer is poly(methylmethacrylate).

6. The composition of claim 5, wherein the cycloaliphatic polyester resin is such as poly(1,4-cyclohexane dimethanol-1,4-dicarboxylate (PCCD).

7. The composition of claim 6, wherein the PCCD is present in the bulk resin component in an amount of 40-80% by weight.

8. The composition of claim 5, wherein the cycloaliphatic polyester resin is present in the bulk resin component in an amount of 40-80% by weight.

9. The composition of claim 1, wherein said cycloaliphatic polyester resin is present in an amount of 50 to 80 parts by weight, said acrylic polymer is present in an amount of 45 to 20 parts by weight, and said impact modifier is present in an amount of 5 to 25 parts by weight.

10. The composition of claim 1, wherein the cycloaliphatic polyester resin consists essentially of the condensation product of a cyclohexyl dicarboxylic acid and a cyclohexyl dialkanol.

11. The molding composition of claim 10, in which said cyclohexyl dicarboxylic acid comprises 1,4-cyclohexyl dicarboxylic acid.

12. The molding composition of claim 10, in which said cyclohexyl dialkanol comprises 1,4-cyclohexyl dimethanol.

13. The molding composition of claim 1, in which the impact modifier has a glass transition temperature of 0° C. or less.

14. The composition of claim 1, further comprising a phase compatibilizer selected from the group consisting of a polycarbonate polymer or a styrene-acrylonitrile polymer.

15. The molding composition of claim 14, in which the compatibilizer is a bis phenol A polycarbonate resin.

16. The molding composition of claim 14, in which the compatibilizer comprises a styrene-acrylonitrile polymer containing 25% to 35% by weight of acrylonitrile.

17. The composition of claim 1, further comprising a colorant selected from the group consisting of phthalocyanines, quinacridones, perylenes, benzimidazolones, azo pigments, azo methines and diketopyrrolo-pigments, and mixtures thereof.

18. The molding composition of claim 1, further comprising an effect-producing amount of a metallic-effect pigment, a metal oxide-coated metal pigment, a platelike graphite pigment, a platelike molybdenumdisulfide pigment, a pearlescent mica pigment, a metal oxide-coated mica pigment, an organic effect pigment, a layered light interference pigment, a polymeric holographic pigment or a liquid crystal interference pigment.

19. The composition of claim 1, further comprising a partially chlorinated copper phthalocyanine colorant.

20. A method for preparing a molding composition comprising the step of melt blending:
a) 5 to 93 percent by weight of cycloaliphatic polyester resin having a melt viscosity of at least 6000 poise;
b) 5 to 93 percent by weight of an acrylate polymer or co-polymer; and
c) 2 to 30 percent by weight of an impact modifier consisting essentially of a shell comprising repeating units derived from a C1-12 alkyl(meth)acrylate and a rubbery core having weatherability properties.

21. The method of claim 20, wherein the cycloaliphatic polyester resin is such as poly(1,4-cyclohexane-dimethanol 1,4 dicarboxylate (PCCD).

22. The method of claim 21, wherein the alkyl acrylate polymer is poly(methyl methacrylate).

23. The method of claim 20, wherein the alkyl acrylate polymer is poly(methyl methacrylate).

24. The method of claim 20, wherein a phase compatibilizer selected from the group consisting of a polycarbonate polymer and a styrene-acrylonitrile polymer is melt blended into the composition.

25. The method of claim 20, further comprising the step of adding a colorant is to the composition.

26. The method of claim 25, wherein the colorant is added in a resin carrier.

27. The method of claim 26, wherein the resin carrier is the cycloaliphatic polyester.

28. The method of claim 26, wherein the resin carrier is the alkyl acrylate polmer or copolymer.

29. The method of claim 26, wherein the colorant is a partially chlorinated copper phthalocyanine.

30. The method of claim 25, wherein the colorant is a partially chlorinated copper phthalocyanine.
